(19) United States
(12) Patent Application Publication
(10) Pub. No.: US 2011/0086563 A1
(43) Pub. Date: Apr. 14, 2011

(54) ADHESIVE STRAPPING TAPE

(75) Inventors: Frank Lange, Hamburg (DE); Wolfgang David, Hamburg (DE); Henning Latz, Luneburg (DE)

(73) Assignee: TESA SE, HAMBURG (DE)

(21) Appl. No.: 12/993,548

(22) PCT Filed: Jul. 20, 2009
(86) PCT No.: PCT/EP09/05256

§ 371 Date: Dec. 16, 2010

(30) Foreign Application Priority Data
Jul. 23, 2008 (DE) 10 2008 034 370.6

(51) Int. Cl. C09J 7/02; B32B 5/02; C09J 7/04

(52) U.S. Cl. 442/1; 428/355 BL; 428/354; 442/286

(57) ABSTRACT

Adhesive strapping tape having improved stability toward UV light for an extended time period, and being removable without residue after such extended time period, having a carrier with an adhesive applied to at least one side, the adhesive being composed of at least one block copolymer P1 having one or more vinylaromatic terminal blocks and at least one block of conjugated dienes, more than 80% of the terminal double bonds formed by 1,2-linkage being hydrogenated while less than 30% of the double bonds in the main chain, formed by 1,4-linkage being hydrogenated, and at least one block copolymer P2 having one or more terminal blocks of vinylaromatics and at least one block of conjugated dienes wherein at least 95% of the double bonds are hydrogenated.

The invention relates to an adhesive strapping tape having an adhesive based on vinylaromatic block copolymers, the tape being stable toward UV light for a relatively long time period and then being removable without residue.

As compared with conventional, acrylate-based adhesives, which are likewise very aging-resistant and stable toward UV light, the redetachability performance of the SBBS adhesives is significantly more advantageous, similar to that of adhesives based on natural rubber or on synthetic rubbers such as SIS. The latter, however, do not have particularly good aging stability or UV light stability. For this reason, either adhesive tapes with these adhesives are not used for applications where there is UV irradiation, or the adhesive tapes must be protected, at cost and inconvenience, from the UV radiation by means of additives in the adhesive and/or by the use of carrier materials featuring a high degree of UV light absorption. Even then, these tapes generally only satisfy relatively minor demands in terms of UV resistance, by comparison with tapes featuring polyacrylate-based adhesives.

The residueless removability (redetachability) of a strapping tape from various substrates is dependent essentially on the peel forces which develop, after different periods of time, when the tape is detached from the substrates in question. Ideally, the peel force, in comparison to the initial force, increases only slightly or even not at all, since with increasing peel force there is an increase in the risk either of the carrier tearing or of residues remaining. Hence, in the case of forces that are too high, the film carrier may fail and tear and/or split. Other results of excessively high peel forces may be either the cohesive splitting of the adhesive or else the adhesive failure of the adhesive as a consequence of detachment from the carrier.

In all cases, unwanted residues of the adhesive tape on the substrate are obtained, whether in the form of parts of the tape itself or of parts of the adhesive.

Accordingly, the ratio between peel force after and before storage on the substrates in question may serve as a quality feature. The larger this ratio, the poorer, typically, is the redetachability, synonymous with the risk of residues occurring.

Despite generally excellent UV stability and aging stability of acrylate adhesives, they are used relatively seldom in the area of adhesive strapping tapes. The reasons for this, as well as the fairly low bond strengths typically displayed by acrylate adhesives on materials with low surface energy, such as polyethylene or polypropylene, for example, include what is called the peel increase tendency of the adhesives. By this is meant the process whereby the peel force from the substrate (bond force) increases significantly in the initial period following application. Experience has shown that longer storage duration and increased temperatures and humidities reinforce this process.

This mechanism must be taken into account in the design of a redetachable adhesive tape with acrylate adhesive, and therefore either requires carrier materials of particularly high tensile strength or else limits the use of such an adhesive tape to surfaces on which the peel increase tendency produces only moderate bond strengths.

For adhesive strapping tapes, use is made predominantly of oriented carrier materials such as MoPP, for example. Although these materials have extremely high tensile strength in machine direction, their material and processing often mean, however, that they have fairly low strengths in the z-direction, in other words in the direction of the least extent of the film. Particularly in the event of rapid removal at an acute angle, which although unfavorable nevertheless occurs in practice, it is possible with these adhesive strapping tapes, even at bond strengths of more than 5 N/cm, for the adhesive tape carrier to rupture in the z-direction and splice open. At the same time, such bond strengths also impose increased requirements with regard to the efficiency of the primer and/or the anchorage of the adhesive on the film carrier, and with regard to the cohesion of the adhesive.

A further disadvantage of the increased bond strengths of adhesive strapping tapes should not go unmentioned at this point. This disadvantage is that the increase in the bond strengths also entails an increased risk of the substrate being damaged in the course of the removal process, as for example by the lifting of paint coatings.

There is therefore a need for an adhesive strapping tape which can be employed universally on all substrates relevant for the application, examples being the plastics ABS, PS, PP, PE, PC, and POM, and various metals, and solventborne, waterborne, and powder-applied coatings, and which at the same time adheres reliably to these substrates, with sufficiently high bond strengths of, in general, at least 3 N/cm, yet nevertheless can be removed without residue or damage even after prolonged storage and UV irradiation.

Although adhesive strapping tapes are utilized across a great variety of applications, they have certain key properties allowing them to meet the particular requirements to which they are subject. These properties—without making any claim to completeness—include very high tensile strength (ultimate tensile force), a very good stretch resistance, corresponding to a high modulus at low levels of elongation, and a low elongation at break, a sufficient but not excessive bond strength, a graduated bond strength to the tapes' own reverse, residue-free redetachability after the stresses of the application itself, robustness of the carrier with respect to mechanical load, and also, for certain applications, the resistance of the adhesive tape to UV irradiation and to numerous chemicals.

Whereas some of the properties can be attributed to the adhesive or to other functional layers of the adhesive masking tape, the stretchability and the tensile strength are based substantially on the physical properties of the carrier material used.

For adhesive strapping tapes, in view of the particular mechanical demands, it is general practice to use oriented film carriers. Through orientation, synonymous with a stretching of the primary film, formed primarily in the production operation, in one or more preferential directions, it is possible to exert a controlled influence on the mechanical properties. So-called biaxially oriented films may either be stretched sequentially, the primary film first, after having been formed by extrusion with a slot die, being stretched in machine direction, by being passed over a sequence of rollers at a film transport speed which is greater than the speed on emergence from the extrusion die. In a drawing unit, the film is then stretched in the transverse direction. The stretching of the film in two directions may also be performed in one step (compare, for example, U.S. Pat. No. 4,675,582 A and U.S. Pat. No. 5,072,493 A).

Within the market for adhesive tapes there are likewise tapes whose BoPP carriers have been oriented in a blown film process.

In one preferred embodiment, carriers for adhesive strapping tapes are oriented exclusively in machine direction. With this method it is possible to achieve polypropylene films having the highest tensile strengths and moduli. The draw ratio typically used, in other words the ratio between the length of a primary film compartment to the corresponding compartment in the end product, is between 1:5 to 1:10. Particularly preferred are draw ratios between 1:7 and 1:8.5. The very high stretch resistance of polypropylene films oriented exclusively monoaxially is one of the most essential properties for their use as carriers for adhesive strapping tape. In many applications, such as the securement of stacked cardboard boxes, the bundling of articles, including heavy articles, or the fastening of tensioned ends of metal sheets wound up in roll form, to name but a few examples, this property is vital.

The principle of orientation as an effect lies in the orientation of the polymer's molecular chains and in the crystal structures formed as a result, and also in the orientation of the amorphous regions in particular preferential directions, and in the associated increase in strength. In principle, however, there is also a reduction in the strength in the direction in which orientation has not taken place. Correspondingly, the case of the BoPP and BoPET films, and especially in the case of the MoPP films, there is a significantly lower strength of the films in the z-direction (in the direction of least extent of the film). Although the enormously high tensile strength of such carriers is profitably used for the application and, for example, in machine direction, maximum loads of more than 350 N/mm² (see, for example, in DE 10 2006 062 249 A1) are held, the disadvantageous inclination of such carriers to fail or splice open in z-direction is regularly manifested on redetachment from substrates or on unwind from the roll, even if only moderate to average forces of little more than 6 N/cm occur, since in these operations the carrier is also loaded in the z-direction.

It is an object of the invention to obtain a marked improvement over the prior art and to provide an adhesive tape which meets the stated requirements.

This object is achieved by means of an adhesive tape as characterized more closely in the main claim. The dependent claims describe advantageous embodiments of the invention. Further embraced is the use of the adhesive tape of the invention.

The invention accordingly provides an adhesive tape having a carrier comprising a film, to which at least one side of which an adhesive is applied, the adhesive being composed of
at least one block copolymer P1 having one or more terminal blocks composed of vinylaromatics and having at least one block composed of conjugated dienes, wherein more than 80% of the terminal double bonds formed by 1,2-linkage are hydrogenated, while less than 30% of the double bonds in the main chain, formed by 1,4-linkage, are hydrogenated, and
at least one block copolymer P2 having one or more terminal blocks composed of vinylaromatics and having at least one block composed of conjugated dienes, wherein at least 95% of the double bonds are hydrogenated.

As film carriers it is possible to use all films obtained by the processes described above. The films advantageously possess an elongation at break of between 20% and 160%, in one particularly advantageous embodiment between 30% and 50%.

The films advantageously possess a thickness of between 25 μm and 150 μm, in one particularly advantageous embodiment, however, between 35 μm and 100 μm.

At this point it is noted that, in the case of the adhesive tapes reinforced by attachment of fibers and/or filaments and/or woven filament fabrics or filament scrims, the elongation at break of the products is generally determined by the mechanical properties of the fiber materials and those of the filament geometries. Such products typically have elongations at break of 3% to 25%, with 5% to 8% being particularly preferred. The elongation at break is determined in accordance with the AFERA test method 5004.

In accordance with one preferred embodiment of the invention, the film is composed of
unoriented or monoaxially or biaxially oriented polypropylene
unoriented or monoaxially oriented polyethylene or
polyester.

The film may further be composed of blends of polyethylene and propylene.

In accordance with a further advantageous embodiment of the invention, the film comprises at least in part copolymers of propylene or copolymers of polyethylene.

It has emerged as being advantageous, furthermore, if the film comprises at least two layers produced in particular by coextrusion.

Where the use of the adhesive tape requires an even greater strength or stretch resistance than that obtainable by a film carrier alone, the carrier may be further reinforced by attachment of fibrous materials, especially individual filaments extending in machine directions, or woven filament fabrics or filament scrims. Methods known to the skilled person are the placement of aforementioned fibrous materials onto a precoated film web, and subsequent coating, performed in a separate production step or else in the same production step, with the adhesive that is actually active subsequently.

As carriers for the adhesive tape it is possible to use the described films directly, with in general at least one corona pretreatment or else flame pretreatment of the side that is subsequently coated with the adhesive, in order to anchor the adhesive more effectively on the carrier. A further improvement in adhesion, synonymous with the anchorage of the adhesive on the carrier, may be accomplished through the use of primers. With these it is possible on the one hand to purposively adjust the surface energy and on the other hand, when using isocyanate-containing primers, for example, to pursue chemical attachment of the elastomeric component of the adhesive to the carrier.

The typical application weight of the primer per unit area is between 0.1 and 10 g/m². A further possibility of enhancing the anchorage lies in the use of carrier films which through coextrusion at the premises of the film manufacturer are specifically equipped with a polymer surface which is favorable for attachment to the pressure-sensitive adhesive.

In order to facilitate unwindability, the adhesive tape carrier is provided, on the side opposite the adhesive, with a layer which reduces the adhesion of the adhesive. During the production of the adhesive tape of the invention, use is made of release coatings based on commercially available polyvinyl stearyl carbamates, which are applied in the form of dilute solutions in toluene, and of silicone coatings. Their suitability is proven. In principle, however, it is possible without exception to use all other release layers or release coatings that are known to the skilled person and are suitable for ensuring a sufficiently low unwind force.

In one advantageous embodiment of the adhesive, the block copolymers have a polyvinylaromatic fraction of 10% to 35% by weight.

In another advantageous embodiment, the fraction of the two vinylaromatic block copolymers in total, based on the overall adhesive, is 20% to 70%, preferably 30% to 60%, more preferably 35% to 55%, by weight.

In the preparation of block copolymers based on vinylaromatics, preferably styrene and 1,3-dienes, particularly isoprene and butadiene, the dienes in the diene block are incorporated both with 1,2-linkage and with 1,4-linkage. The fraction of 1,2-linked dienes may be controlled through the solvent, the temperature or the catalyst. Since the 1,2-linked dienes contain a terminal double bond, while in the case of the 1,4-linked dienes the double bond is in the main chain, it is possible to carry out selective hydrogenation of the terminal—and hence more reactive—double bonds.

Block copolymers employed are those polymers which on the one hand possess blocks of vinylaromatics (A blocks) such as styrene, for example, and on the other hand possess blocks formed by polymerization of 1,3-dienes (B blocks) such as butadiene and isoprene, for example, or a mixture of both. The B blocks are polymerized such that they possess a high fraction of vinyl groups as a result of 1,2-linkage of more than 20% which are hydrogenated in contrast to the double bonds in the main chain. If the unhydrogenated block copolymer is an SBS, the product of the selective hydrogenation is what is called an SBBS (styrene-butadiene/butylene-styrene). Since the selectivity of the hydrogenation is not 100%, it is possible to employ block copolymers more than 80% of whose vinylic double bonds, formed by 1,2-linkage, are hydrogenated, whereas the double bonds in the main chain are hydrogenated to an extent only of 30% at most.

As a second component, block copolymers are employed which on the one hand possess blocks of vinylaromatics (A blocks) such as styrene, for example, and on the other hand possess blocks formed by polymerization of 1,3-dienes (B blocks) such as butadiene and isoprene, for example, or a mixture of both, a fraction of more than 95% of the overall double bonds in the B blocks being hydrogenated.

The block copolymers may have a linear A-B-A structure. Likewise amenable to use are block copolymers of radial architecture, and also star-shaped and linear multiblock copolymers. As a further component it is possible to use A-B diblock copolymers.

In place of the preferred polystyrene blocks it is also possible to utilize polymer blocks based on other aromatics-containing homopolymers and copolymers (preferably C₈ to C₁₂ aromatics) having glass transition temperatures of greater than around 75° C., such as α-methylstyrene-containing aromatic blocks, for example.

The two elastomers, one partially hydrogenated (P1) and the other at least 95% hydrogenated (P2), are present in accordance with the invention in a ratio (weight fractions) of 25:75 up to a ratio of 90:10, preferably in the range from 40:60 and 80:20.

Tackifiers used are tackifier resins which are compatible with the elastomer block of the vinylaromatic block copolymers. Suitable tackifier resins include preferably unhydrogenated, partially hydrogenated or fully hydrogenated resins based on rosin or on rosin derivatives, hydrogenated polymers of dicyclopentadiene, unhydrogenated or partially, selectively or wholly hydrogenated hydrocarbon resins based on C₅, C₅/C₉ or C₉ monomer streams, or polyterpene resins based on α-pinene and/or β-pinene and/or δ-limonene. Aforesaid tackifier resins may be used either alone or in a mixture.

Not only resins which are solid at room temperature, but also liquid resins, may be employed in this context.

In order to ensure high aging stability and UV stability, hydrogenated resins are preferred.

Other additives which may typically be utilized include the following:
plasticizing agents such as, for example, plasticizer oils or low molecular mass liquid polymers such as, for example, low molecular mass polybutenes
primary antioxidants such as, for example, sterically hindered phenols
secondary antioxidants such as, for example, phosphites or thioethers
in-process stabilizers such as, for example, C radial scavengers
light stabilizers such as, for example, UV absorbers or sterically hindered amines
processing assistants
fillers such as fibers, carbon black, zinc oxide, titanium dioxide, solid microbeads, solid or hollow glass beads, silica, silicates, chalk
end block reinforcer resins, and also
if desired, further polymers preferably of elastomeric type; elastomers which can be utilized accordingly include, among others, those based on pure hydrocarbons, such as unsaturated polydienes, for example, such as naturally or synthetically produced polyisoprene or polybutadiene, elastomers with substantial chemical saturation, such as, for example, saturated ethylene-propylene copolymers, α-olefin copolymers, polyisobutylene, butyl rubber, ethylene-propylene rubber, and also chemically functionalized hydrocarbons such as, for example, halogen-containing, acrylate-containing or vinyl ether-containing polyolefins, to name but a few.

It is also in accordance with the invention for the adhesive to contain none of the stated adjuvants.

The general expression “adhesive tape” in the sense of this invention encompasses all sheetlike structures such as two-dimensionally extended films or film sections, tapes with extended length and limited width, tape sections and the like, and also, lastly, diecuts or labels.

### Preparation of the PSAs

The preparation and processing of the pressure-sensitive adhesives (PSAs) may take place from solution, from dispersion, and from the melt. Preferred preparation and processing procedures are from solution and also from the melt. Particularly preferred is the manufacture of the adhesive from the melt, in which case, in particular, batch methods or continuous methods may be employed. Particularly advantageous is the continuous manufacture of the PSAs by means of an extruder.

The PSAs thus prepared may then be applied to the carrier by the techniques that are common knowledge. In the case of processing from the melt, this may involve application techniques via a nozzle or a calender.

In the case of processes from solution, coating operations with knives, with doctor blades or with nozzles are known, to name but a few.

### TEST METHODS

### Bond Strength

The determination of the bond strength (in accordance with AFERA 5001) was carried out as follows: The defined substrate used was galvanized steel sheet with a thickness of 2 mm (obtained from Rocholl GmbH). The bondable sheetlike element under investigation was cut to a width of 20 mm and a length of around 25 cm, provided with a handling section, and immediately thereafter pressed five times using a 4 kg steel roller, with a rate of advance of 10 m/min, onto the selected substrate. Immediately after that, the bondable sheetlike element was peeled from the substrate at an angle of 180° using a tensile testing instrument (from Zwick), and the force required to achieve this at room temperature was recorded. The measured value (in N/cm) resulted as the average from three individual measurements.

### UV Test

To measure the UV stability, the specimens in 20 mm width and 25 cm length were applied to test sheets with a length of 20 cm and a width of 5 cm, and were rolled on 5 times using a rubberized steel roller with a weight of 2 kg. Test substrates selected were galvanized steel sheet (DC01 ZE 25/25), ABS, and polystyrene (PS). Fifteen strips were prepared for each test system.

The specimens were stored with the adhesive tape side upward in a UV chamber with xenon lamp, with an irradiance of 500 W/m².

Continually after irradiation time of 24 h in each case, the strips were peeled from individual sample plates, after reconditioning to room temperature, at 90° and 180°, and were assessed for tearing and residues. The maximum time period achieved, in days, is determined by the first incidence of residues. The total test duration was limited to 12 days. Correspondingly, the evaluation of a specimen as “12 days” means that the specimen did not undergo any visible damage as a result of UV exposure throughout the whole test duration.

### Testing of Bond Strength After Storage

The procedure for measuring the bond strength after storage corresponds in principle to that for the initial bond strength, with the difference that the specimens, applied in the defined way as described therein, are subjected to measurement only after storage for 5 days (in horizontal form) under test conditions of 60° C. and 95% relative humidity and after subsequent reconditioning for at least 8 h at 23° C. and 50% relative humidity.

The invention is illustrated in detail below by a number of examples, without wishing thereby to restrict the invention.

For these examples, a film of monoaxially oriented polypropylene with a thickness of 50 μm is used as carrier, the film being corona-pretreated on the side of subsequent coating with adhesive, in order to improve the adhesion of the adhesive. The opposite side of the carrier is provided either with a silicone or with a carbamate-based release coating layer, in this case a silicone.

According to the results of the measurements of elongation at break, the carrier has an ultimate tensile force of 160 N/10 mm with an elongation at break of 35%.

The furnished film carrier was coated with an SBBS adhesive having the formula below, in two different ways.

| | | |
|---|---|---|
| 70 parts | Tuftec P 1500 | SBBS with 30% by weight block |
| | | polystyrene content and around 68% by |
| | | weight diblock content, from Asahi |
| 30 parts | Kraton G 1657 | SEBS with 13% by weight block |
| | | polystyrene content and around 36% by |
| | | weight diblock content, from Kraton |
| 100 parts | Escorez 5600 | Hydrogenated HC resin having a softening |
| | | point of 100° C., from Exxon |
| 25 parts | Ondina G 17 | White oil comprising paraffinic and |
| | | naphthenic fractions, from Shell |

SBBS 01—the adhesive was compounded in a hotmelt process, in an extruder, and coated via a 3-roll applicator mechanism onto the furnished carrier.

SBBS 02—the SBBS adhesive produced in solution (solvent: toluene with a solids fraction of 40%) was coated directly onto the corona-pretreated film carrier, which was subsequently dried in an oven at 120° C. for 7 minutes.

The comparative investigations were carried out with various commercially available adhesive strapping tapes. An adhesive tape with an acrylate adhesive was included in the test series. In addition, three products with natural rubber-based adhesives are used (NR 01, NR 02, and NR 03).

| | |
|---|---|
| Acrylate | tesa product (tesa 64250), adhesive strapping tape with an |
| | MoPP carrier and a polyacrylate-based adhesive; adhesive |
| | coatweight: 28 g/m² |
| NR 01 | tesa product (tesa 64283), adhesive strapping tape with an |
| | MoPP carrier and a natural rubber-based adhesive; adhesive |
| | coatweight: 25 g/m² |
| NR 02 | tesa product (tesa 4298), adhesive strapping tape with an |
| | MoPP carrier and a natural rubber-based adhesive; adhesive |
| | coatweight: 27 g/m² |
| NR 03 | competitor product (Nitto Denko 3800K), adhesive |
| | strapping tape with a polyester carrier and a natural |
| | rubber-based adhesive; adhesive coatweight: 30 g/m² |

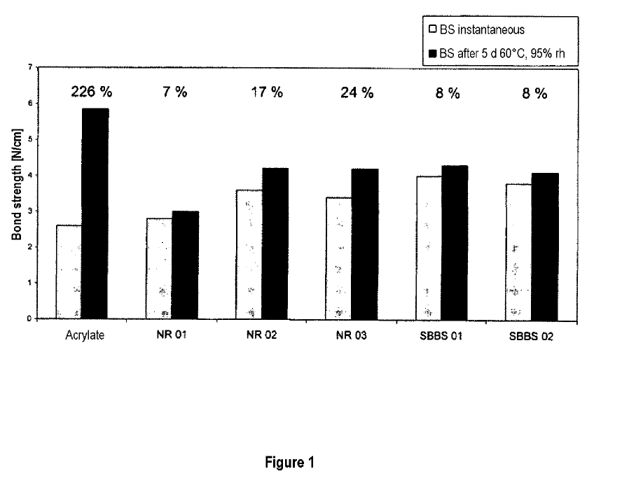

FIG. 1 shows the measurement results for the bond strength measurements performed on the various adhesive tapes in each case on galvanized steel before and after storage for 5 days at 60° C. and 95% relative humidity.

For illustration, the top of the diagram shows the percentage increase in bond strengths as a result of storage (ratio of bond strength after storage to initial bond strength, multiplied by 100). Also given is the maximum number of days achieved in the UV test after which the tapes could still be removed without residue.

Clearly in evidence is the jump between the acrylate adhesives and the NR and SBBS adhesives. While the acrylate tape undergoes an increase in bond strengths through climatic storage by significantly more than 200%, and therefore also tears when rapidly peeled off by hand, the natural rubber-based tapes, and especially the tapes with SBBS adhesives, exhibit only a marginal increase in bond strengths.

At the same time, only the acrylate tape and the SBBS tapes exhibit any notable UV resistance.

In accordance with the attached table, which shows the number of days withstood under UV irradiation (meaning days without residues being observed on the bond substrate on subsequent redetachment), it is found that the rubber-based adhesives fail rapidly, whereas for the SBBS tapes even after 12 days' test duration there is no apparent damage due to UV exposure in evidence.

TABLE
Number of days withstood under UV irradiation

| Acrylate | NR 01 | NR 02 | NR 03 | SBBS 01 | SBBS 02 |
|---|---|---|---|---|---|
| 12 | 0 | 1 | 0 | 12 | 12 |

1. An adhesive tape having a carrier comprising a film to at least one side of which an adhesive is applied, the adhesive being composed of
at least one block copolymer P1 having one or more terminal blocks composed of vinylaromatics and having at least one block composed of conjugated dienes, wherein more than 80% of the terminal double bonds formed by 1,2-linkage are hydrogenated, while less than 30% of the double bonds in the main chain, formed by 1,4-linkage, are hydrogenated, and
at least one block copolymer P2 having one or more terminal blocks composed of vinylaromatics and having at least one block composed of conjugated dienes, wherein at least 95% of the double bonds are hydrogenated.

2. The adhesive tape of claim 1,
wherein
the film is composed of
unoriented or monoaxially or biaxially oriented polypropylene
unoriented or monoaxially oriented polyethylene or
polyester.

3. The adhesive tape of claim 1,
wherein
the film is composed of blends of polyethylene and propylene.

4. The adhesive tape of claim 1, wherein
the film is composed at least in part of copolymers of propylene or copolymers of polyethylene.

5. The adhesive tape of claim 1, wherein
the film comprises at least two layers produced by coextrusion.

6. The adhesive tape of claim 1, wherein
the adhesive tape comprises fibrous reinforcing materials selected from the group consisting of filaments, woven filament fabrics and filament scrims, which either are placed directly on the film carrier or are inserted in the adhesive.

7. The adhesive tape of claim 1, wherein
the vinylaromatics comprise styrene.

8. The adhesive tape of claim 1, wherein
the two block copolymers P1 and P2 are present in a ratio of 25:75 up to 90:10 weight fractions.

9. The adhesive tape of claim 1, wherein
the block copolymer P1 is a partially hydrogenated styrene-butadiene-styrene block copolymer.

10. The adhesive tape of claim 1, wherein
the polyvinylaromatic fraction of the block copolymers P1 and P2 is between 10% and 35% by weight.

11. The adhesive tape of claim 1, wherein
the fraction of the two vinylaromatic block copolymers in total, based on the overall adhesive, is 20% to 70% by weight.

12. The adhesive tape of claim 1, wherein
the adhesive further comprises diblock copolymers.

13. The adhesive tape of claim 1, wherein
the adhesive further comprises tackifier resins.

14. The adhesive tape of at least one of the preceding claim 1, wherein
the adhesive comprises at least one UV protectant and/or other blending components selected from the group consisting of plasticizers, aging inhibitors, processing assistants, fillers, dyes, optical brighteners, stabilizers, endblock reinforcer resins.

15. An adhesive strapping tape for bundling and palletizing cardboard-boxed items and other goods comprising the adhesive tape of claim 1.

16. The adhesive tape of claim 8 wherein said ratio is 40:60 up to 80:20.

17. The adhesive tape of claim 11, wherein said fraction of the two vinylaromatic block copolymers is 30% to 60%.
